(19) United States
(12) Patent Application Publication
(10) Pub. No.: US 2011/0171967 A1
(43) Pub. Date: Jul. 14, 2011

(54) METHOD AND APPARATUS FOR REQUESTING RESOURCE ALLOCATION IN MOBILE COMMUNICATION TERMINAL

(75) Inventors: Joo-Hyun LEE, Paju-si (KR); Beom-Yong LEE, Yongin-si (KR)

(73) Assignee: SAMSUNG ELECTRONICS CO. LTD., Suwon-si (KR)

(21) Appl. No.: 12/986,417

(22) Filed: Jan. 7, 2011

(30) Foreign Application Priority Data
Jan. 8, 2010 (KR) 10-2010-0001608

(51) Int. Cl. H04W 72/04

(52) U.S. Cl. 455/452.1

(57) ABSTRACT

A method and an apparatus for requesting resource allocation in a mobile communication terminal are provided. In the method, a priority of each logical channel when there is transmission data to be transmitted is determined. A weight is applied to a size of transmission data for each logical channel according to the priority. A Buffer Status Report (BSR) message representing the size of the transmission data for each logical channel to which the weight has been applied is generated. The BSR message is transmitted to a base station.

### PRIORITY

This application claims the benefit under 35 U.S.C. §119(a) of a Korean patent application filed in the Korean Intellectual Property Office on Jan. 8, 2010 and assigned Serial No. 10-2010-0001608, the entire disclosure of which is hereby incorporated by reference.

### BACKGROUND OF THE INVENTION

1. Field of the Invention

The present invention relates to a method and an apparatus for requesting resource allocation in a mobile communication terminal. More particularly, the present invention relates to a method and an apparatus for requesting resource allocation according to a priority for each logical channel.

2. Description of the Related Art

In a Long Term Evolution (LTE) system of the related art, a terminal reports a size of data to be transmitted to a base station and is allocated a corresponding uplink resource. That is, in the LTE system, a terminal transmits a Buffer Status Report (BSR) message representing a size of data to be transmitted by each logical channel group to a base station to inform the base station of a size of an uplink resource that the terminal desires to be allocated. The base station allocates the uplink resource for the each logical channel group with reference to the BSR message. For example, in the case where data is to be transmitted by only one logical channel group, the terminal determines a data size to be transmitted by the one logical channel group, and then searches for an index corresponding to the data size in a table stored in advance to transmit a short BSR message including the index. In contrast, when data is to be transmitted by a plurality of logical channel groups, the terminal determines a size of data to be transmitted by each of the plurality of logical channel groups, detects indexes corresponding to the data size from the table stored in advance, and transmits a long BSR message including the indexes. Here, the short BSR message denotes a BSR message including only information for a portion of logical channels among logical channel groups supported by the terminal. The long BSR message denotes a BSR message including information regarding all logical channel groups supported by the terminal.

As described above, in the case where the base station is requested by the terminal to allocate a resource, and allocates a resource to the relevant terminal according to the request, the base station may frequently allocate a smaller amount of resources than an amount requested by the terminal due to limited available resources. In the case where the base station allocates a smaller amount of resources than the amount requested by the terminal, the terminal should divide data to be transmitted suitable for the small amount of resources to transmit only a portion of the data, and transmit the rest of data via the next resource. However, due to this divided transmission, a data transmission speed deteriorates.

### SUMMARY OF THE INVENTION

An aspect of the present invention is to address at least the above-mentioned problems and/or disadvantages and to provide at least the advantages described below. Accordingly, an aspect of the present invention is to provide a method and an apparatus for requesting resource allocation in a mobile communication terminal.

Another aspect of the present invention is to provide a method and an apparatus for requesting resource allocation according to a priority for each logical channel in a mobile communication terminal.

Still another aspect of the present invention is to provide a method and an apparatus for giving weight to a data size to be transmitted according to a priority for each logical channel to request resource allocation in a mobile communication terminal.

In accordance with an aspect of the present invention, a method for requesting resource allocation in a mobile communication terminal is provided. The method includes determining a priority of each logical channel when there is transmission data to be transmitted, applying a weight to a size of transmission data for each logical channel according to the priority, generating a Buffer Status Report (BSR) message representing the size of the transmission data for each logical channel to which the weight has been applied, and transmitting the BSR message to a base station.

In accordance with another aspect of the present invention, an apparatus for requesting resource allocation in a mobile communication terminal is provided. The apparatus includes a transmission data determining unit for determining a size of transmission data of each logical channel when there is transmission data to be transmitted, a weight apply unit for determining a priority of the each logical channel, and for applying a weight to the size of the transmission data of the each logical channel according to the priority of the each logical channel, a generator for generating a BSR message representing the size of the transmission data for the each logical channel to which the weight has been applied, and a transmitter for transmitting the BSR message to a base station.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings in which:

FIG. 1 is a block diagram illustrating a mobile communication terminal according to an exemplary embodiment of the present invention; and

FIG. 2 is a flowchart illustrating a procedure for requesting resource allocation in a mobile communication terminal according to an exemplary embodiment of the present invention.

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Exemplary embodiments of the present invention provide a method and an apparatus for giving weight to a size of transmission data according to a priority for each logical channel in a mobile communication terminal. In the following description, the mobile communication terminal supports a plurality of logical channels, and the plurality of logical channels are classified into a predefined number of logical channel groups. Respective logical channels belonging to one logical channel group have different priorities, and the priorities may change depending on a circumstance.

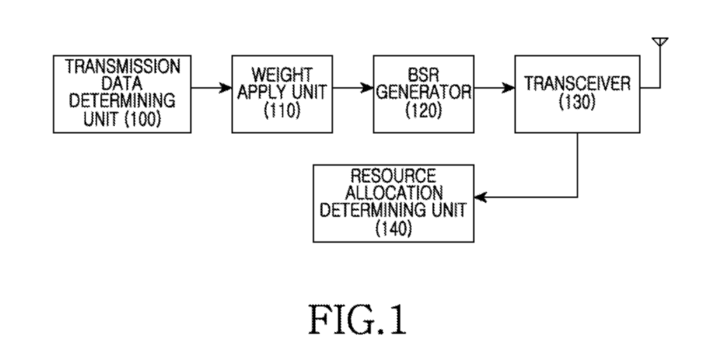

FIG. 1 is a block diagram illustrating a mobile communication terminal according to an exemplary embodiment of the present invention.

Referring to FIG. 1, the mobile communication terminal includes a transmission data determining unit 100, a weight apply unit 110, a Buffer Status Report (BSR) generator 120, a transceiver 130, and a resource allocation determining unit 140.

When there is data to be transmitted in the mobile communication terminal, the transmission data determining unit 100 determines a logical channel group corresponding to the data to be transmitted, determines the size of the transmission data corresponding to each logical channel included in the relevant logical channel group, and provides the same to the weight apply unit 110.

When receiving the size of the transmission data of the each logical channel included in the logical channel group corresponding to the data to be transmitted from the transmission data determining unit 100, the weight apply unit 110 determines a priority of each relevant logical channel, and applies a weight to the transmission data size of the each logical channel according to the priority. For example, the weight apply unit 110 may apply a high weight to a relevant transmission data size of a logical channel of a high priority. Here, a priority of the each logical channel may be set and stored in advance, and may change depending on a circumstance.

For example, when receiving transmission data sizes of logical channels A to D included in a first logical channel group from the transmission data determining unit 100, the weight apply unit 110 determines priorities of the logical channels A to D. When the logical channels have a priority in the order of the logical channels A, B, C, and D as a result of the determining of the priorities, the weight apply unit 110 multiplies the transmission data size of the logical channel A by a weight α greater than 1, multiplies the transmission data size of the logical channel B by a weight β greater than 1 and less than α, multiples the transmission data size of the logical channel C by a weight γ less than 1, and multiples the transmission data size of the logical channel D by a weight δ less than γ. Here, using some (α,β) of the weights greater than 1 and using some (γ,δ) of the weights less than 1 are for preventing an entire transmission data size from increasing rapidly. Of course, all of the weights may be set to values greater than or equal to 1.

The BSR generator 120 receives a data size for each logical channel to which the weight has been applied from the weight apply unit 110, and generates a BSR message including the same. Here, the BSR generator 120 may search for indexes corresponding to data sizes for each logical channel to which the weight has been applied from a table stored in advance, and generate a BSR message including the found indexes. At this point, when a data size for each logical channel for one logical channel group is provided by the weight apply unit 110, the BSR generator 120 may generate a short BSR message including only information regarding one logical channel group. When a data size for each logical channel for a plurality of logical channel groups is provided by the weight apply unit 110, the BSR generator 120 may generate a long BSR message including information regarding the plurality of logical channel groups. The BSR generator 120 provides the generated BSR message to the transceiver 130.

The transceiver 130 transmits the BSR message provided by the BSR generator 120 to a base station via an antenna, and receives a signal representing a resource allocation from the base station to provide the same to the resource allocation determining unit 140.

The resource allocation determining unit 140 receives a signal representing the resource allocation from the transceiver 130 to determine an uplink resource allocated to each logical channel of the terminal, and induce to perform a function for transmitting transmission data of each logical channel via the allocated uplink resource.

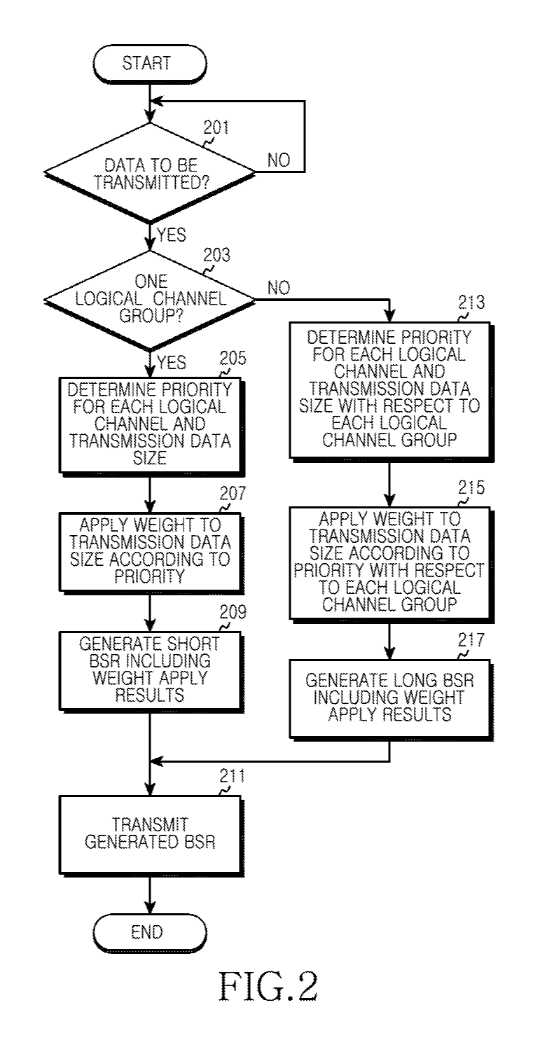

FIG. 2 is a flowchart illustrating a procedure for requesting resource allocation in a mobile communication terminal according to an exemplary embodiment of the present invention.

Referring to FIG. 2, the mobile communication terminal determines whether there is data to be transmitted in step 201. When it is determined that there is data to be transmitted, the mobile communication terminal determines whether only one logical channel group has the data to be transmitted or a plurality of logical channel groups have the data to be transmitted in step 203.

When one logical channel group has the data to be transmitted, the mobile communication terminal determines a priority and a transmission data size of each logical channel included in the logical channel group in step 205, and applies a weight to the transmission data size of the each logical channel according to the priority of the each logical channel in step 207. Here, the mobile communication terminal may apply a high weight to a logical channel having a high priority and applies a low weight to a logical channel having a low priority.

For example, assuming that the transmission data sizes of logical channels A to D included in one logical channel group are k, l, m, and n, respectively, and the logical channels have priorities in the order of the logical channels A, B, C, and D, the mobile communication terminal multiples a transmission data size k of the logical channel A by a largest weight α, multiples a transmission data size l of the logical channel B by a second largest weight β, multiplies a transmission data size m of the logical channel C by a third largest weight γ, and multiplies a transmission data size n of the logical channel D by a smallest weight δ. Here, to prevent an entire transmission data size from increasing rapidly, the mobile communication terminal may set some (α,β) of the weights to a number larger than 1, and set some (γ,δ) of the weights to a number smaller than 1. In addition, the mobile communication terminal may set weights of several logical channels having a high priority to a number greater than 1, and set weights of the rest of the logical channels to 1.

The mobile communication terminal generates a short BSR message including information regarding a transmission data size for each logical channel to which the weight has been applied in step 209, and proceeds to step 211. At this point, the mobile communication terminal may search for indexes corresponding to the data size for each logical channel to which the weight has been applied from a table stored in advance, and generate a short BSR message including the found indexes.

Returning to step 203, when a plurality of logical channel groups have data to be transmitted, the mobile communication terminal determines a priority and a transmission data size of each logical channel included in each of the plurality of logical channel groups in step 213, and applies a weight to a transmission data size of the each logical channel according to a priority of the each logical channel for each of the plurality of logical channel groups in step 215. Here, the mobile communication terminal applies a high weight to a logical channel having a high priority and applies a low weight to a logical channel having a low priority.

The mobile communication terminal generates a long BSR message including information regarding a transmission data size for each logical channel to which the weight has been applied with respect to the plurality of logical channel groups in step 217, and proceeds to step 211. At this point, the mobile communication terminal may search for indexes corresponding to the data size for each logical channel to which the weight has been applied from a table stored in advance, and generate a long BSR message including the found indexes.

The mobile communication terminal transmits the generated BSR message to a base station in step 211, and ends the algorithm according to an exemplary embodiment of the present invention.

According to an exemplary embodiment of the present invention, a mobile communication terminal gives a weight to a data size to be transmitted according to a priority for each logical channel to request resource allocation, so that a logical channel of a higher priority has a higher probability of being allocated a resource and so obtains a high transmission opportunity.

While the invention has been shown and described with reference to certain exemplary embodiments thereof, it will be understood by those skilled in the art that various changes in form and details may be made therein without departing from the spirit and scope of the invention as defined by the appended claims and their equivalents. Therefore, the scope of the present invention should not be limited to the above-described embodiments but should be determined by not only the appended claims but also the equivalents thereof.

What is claimed is:

1. A method for requesting resource allocation in a mobile communication terminal, the method comprising:
determining a priority of each logical channel when there is transmission data to be transmitted;
applying a weight to a size of transmission data for each logical channel according to the priority;
generating a Buffer Status Report (BSR) message representing the size of the transmission data for each logical channel to which the weight has been applied; and
transmitting the BSR message to a base station.

2. The method of claim 1, wherein the applying of the weight comprises applying a high weight to a logical channel of a high priority.

3. The method of claim 1, wherein some of the weights are set to a value greater than 1 and some of the weights are set to a value less than 1.

4. The method of claim 1, wherein the transmitting of the BSR message to the base station comprises:
searching for indexes corresponding to the size of the transmission data for each logical channel to which the weight has been applied from a table stored in advance; and
generating the BSR message comprising the found indexes.

5. The method of claim 1, further comprising:
determining at least one logical channel group corresponding to the transmission data to be transmitted; and
determining a transmission data size for each logical channel with respect to each logical channel group.

6. The method of claim 5, wherein a short BSR is generated when only one logical channel group is determined, the short BSR including information regarding the transmission data size for each logical channel to which the weight has been applied with respect to the one logical channel group.

7. The method of claim 5, wherein a long BSR is generated when a plurality of logical channel groups is determined, the long BSR including information regarding the transmission data size for each logical channel to which the weight has been applied with respect to the plurality of logical channel groups.

8. An apparatus for requesting resource allocation in a mobile communication terminal, the apparatus comprising:
a transmission data determining unit for determining a size of transmission data of each logical channel when there is transmission data to be transmitted;
a weight apply unit for determining a priority of the each logical channel, and for applying a weight to the size of the transmission data of the each logical channel according to the priority of the each logical channel;
a generator for generating a Buffer Status Report (BSR) message representing the size of the transmission data for the each logical channel to which the weight has been applied; and
a transmitter for transmitting the BSR message to a base station.

9. The apparatus of claim 8, wherein the weight apply unit applies a high weight to a logical channel of a high priority.

10. The apparatus of claim 8, wherein the weight apply unit sets some of the weights to a value greater than 1 and sets some of the weights to a value less than 1.

11. The apparatus of claim 8, wherein the generator searches for indexes corresponding to the size of the transmission data for each logical channel to which the weight has been applied from a table stored in advance, and generates the BSR message comprising the found indexes.

12. The apparatus of claim 8, wherein the transmission data determining unit determines at least one logical channel group corresponding to the transmission data to be transmitted, and determines a transmission data size for each logical channel with respect to each logical channel group.

13. The apparatus of claim 12, wherein a short BSR is generated when only one logical channel group is determined, the short BSR including information regarding the transmission data size for each logical channel to which the weight has been applied with respect to the one logical channel group.

14. The apparatus of claim 12, wherein a long BSR is generated when a plurality of logical channel groups is determined, the long BSR including information regarding the transmission data size for each logical channel to which the weight has been applied with respect to the plurality of logical channel groups.
